(19) United States
(12) Patent Application Publication
(10) Pub. No.: US 2011/0035094 A1
(43) Pub. Date: Feb. 10, 2011

(54) SYSTEM AND METHOD FOR AUTOMATIC FAULT DETECTION OF A MACHINE

(75) Inventors: Eric Van Den Berg, Hoboken, NJ (US); Allen McIntosh, Morris Plains, NJ (US)

Correspondence Address: TELCORDIA TECHNOLOGIES, INC., ONE TELCORDIA DRIVE 5G116, PISCATAWAY, NJ, 08854-4157, US

(73) Assignee: Telecordia Technologies Inc., Piscataway, NJ (US)

(21) Appl. No.: 12/535,255

(22) Filed: Aug. 4, 2009

(51) Int. Cl. G06F 19/00

(52) U.S. Cl. 701/33; 701/29

(57) ABSTRACT

A system and method for automatic fault detection of a machine is described. In one embodiment, a semantic structure is constructed using the words and values associated with the parameter identification numbers used by the on-board diagnostic system in a vehicle. The semantic structure is enhanced, analyzed, and reduced to determine the number and arrangement of the clusters that should be independently analyzed in order to produce the most reliable results in a computationally efficient manner. Each cluster is then used to detect outliers that are used to detect vehicle malfunctions.

### FIELD OF THE INVENTION

The present invention relates generally to the automatic detection of machine faults and in particular to the clustering of diagnostic sensor data to detect machine faults.

### BACKGROUND

Vehicles currently sold in the United States are equipped with an on-board diagnostic system that monitors the performance of the various components in the vehicle. For example, the on-board diagnostic system can monitor the engine coolant temperature, catalyst efficiency, the secondary air system, and the like, from sampled data obtained from sensors located throughout the vehicle. The sampled data is often used by the vehicle's repair technician to access the condition of the vehicle to diagnose and repair malfunctions. Additionally, the sampled data can be transmitted to a computer and analyzed by programs to detect and sometimes predict malfunctions in the vehicle.

The sampled data is obtained through a serial data stream that provides data parameters and diagnostic codes in accordance with an industry specification. Scan tools are used to obtain this data in the vehicle which can then be transmitted to a computer program for analysis. However, the on-board diagnostic system generates a large amount of data continuously which is cumbersome to transmit to a computer and for the computer programs to utilize in an effective and computationally efficient manner so that reliable results are achieved.

### SUMMARY

This Summary is provided to introduce a selection of concepts in a simplified form that is further described below. This Summary is not intended to identify key features or essential features of the claimed subject matter, nor is it intended to be used as an aid in determining the scope of the claimed subject matter.

The present invention relates to a technology for automatically detecting machine faults. In a preferred embodiment, the technology is applied to a vehicle fault detection system used to detect malfunctions in a vehicle. The technology uses diagnostic sensed data retrieved from the vehicle's on-board diagnostic system. This data is analyzed to determine hidden patterns that represent the normal operating conditions of the vehicle and abnormalities which are often indicative of a vehicle's malfunction or fault.

The analysis is achieved by grouping the diagnostic sensed data into clusters, where each cluster represents similar data. Each cluster is then independently analyzed by an outlier technique to determine any abnormalities.

In one embodiment, a k-means clustering technique is used. Generally, the k-means clustering technique takes data points and the value of k, and randomly generates k center points. It executes iteratively determining the distance of each data point to the center points, assigning each data point to its closest center point, adjusting the center points to the real centers of the clusters until this process converges. It produces k clusters where each cluster contains similarly-situated data points.

Clustering works well on clusters with well-defined centers, that is where the sampled data points are normally distributed. At times, the distribution of the sampled data is not known or is not normally distributed. Additionally, clustering requires a user to determine the appropriate value of k upfront which is difficult to do. Often these problems impact the reliability of the results. Otherwise dissimilar data would be analyzed together thereby producing erroneous results.

In a preferred embodiment, a semantic space or structure is formed from the word phrases used to describe and represent parameter identification number (PIDs) associated with the on-board diagnostic system. For example, the word phrases or terms used to describe a PID could be “engine coolant temperature”, “engine RPM”, etc. The term semantic space denotes a correlation in the word phrases used in the PID descriptions that is indicative of a hidden structure. The use of several mathematical techniques is employed to estimate this structure and to determine the best value of k.

Initially, this semantic structure is constructed from a term-document matrix, M, whose rows represent the PID descriptions (e.g., “engine coolant temperature”) and whose columns represent the single terms used in the PID descriptions and their associated values (e.g., “engine”, “temperature”, “volts”, etc.). A value in the term-document matrix represents the number of occurrences a particular term appears in a PID description. The term-document matrix is processed to eliminate redundant and irrelevant terms and to normalize its values.

The term-document matrix, M, is then used to construct a similarity matrix. The similarity matrix is a matrix of scores indicating the similarity between two ND descriptions. A higher score is indicative of a strong similarity while a lower score indicates very little similarity. In one embodiment, a semantic similarity matrix W is computed as follows: W=M×M^{T}, where M^{T} is the transpose of M.

In another embodiment, W is a binary matrix (a matrix with only entries 0 or 1), where Wᵢⱼ, the entry in row i and column j, is 1 if PID i and PID j have a term in common, and 0 otherwise.

In another embodiment, the similarity matrix is a co-occurrence matrix, W^{c}, that represents the strength of the relationship between two PIDs by the frequency with which data messages for the two PIDs are received in the same time window (of a given length, which can be specified by the user).

In another embodiment, the similarity matrix is a binary co-occurrence matrix W^{bc}, where W^{bc}ᵢⱼ is 1 if PID i and PID j co-occur in the same time window, and 0 if they do not.

In yet another embodiment, the similarity matrix is a positive linear combination W′ of the semantic similarity matrix W and the co-occurrence similarity matrix W^{c}. This similarity matrix, W′, can be constructed as follows: W′=(a₀×W)+(a₁×W^{c}), where W is the semantic similarity matrix, and W^{c} is the co-occurrence similarity matrix, and a₀ and a₁ are two non-negative numbers which add up to 1. For example, a₀=0.5, and a₁=0.5. The similarity matrix W′, has the advantage of incorporating semantic and numerical domain-specific information related to the PIDs into the matrix and as such, enhances the analysis.

The similarity matrix is then transformed into a graphical representation. The graphical representation is analyzed for connected components. Each set of connected components represent a cluster of similarly-situated PIDs. The number of such sets is used as the value of k and is used to partition the graphical representation into a subset having a more compact representation.

In particular, the similarity matrix is represented by a normalized graph Laplacian as follows: L=I−P, where P is a row-normalized similarity matrix, and I is an identity matrix of the same dimension as P. Singular value decomposition is applied to L producing: L=UDU^{T}, where D is a diagonal matrix whose diagonal elements are the singular values of L. The number of zero-value singular values is used as the lower bound kₘᵢₙ for k. The final value of k is determined as follows: k=kₘᵢₙ+number_of_extra_clusters, where number_of_extra_clusters is a user-defined parameter. The graph is then reduced to the last k columns of matrix U and is denoted as UK.

A clustering technique, such as k-means clustering, is applied to UK, and groups the rows of UK into k distinct clusters, C₁, C₂, . . . , Cₖ. Each cluster represents the arrangement of PIDs that are to be analyzed together since they are closely related in terms of their semantic structure.

The measurement values associated with each PID in a cluster are then analyzed by a fault detection technique, such as, outlier detection to identify any outliers, or data points that are distant from the center point. These outliers are further analyzed for representing possible malfunctions.

### BRIEF DESCRIPTION OF THE DRAWINGS

FIG. 1A is a schematic diagram of a system in accordance with a preferred embodiment.

FIG. 1B is a schematic diagram of a system in accordance with another preferred embodiment.

FIG. 2 is a schematic diagram of a computer readable medium in accordance with a preferred embodiment.

FIG. 3 illustrates the fault detection process in accordance with a preferred embodiment.

Like reference numerals refer to corresponding parts throughout the several views of the drawings.

### DETAILED DESCRIPTION

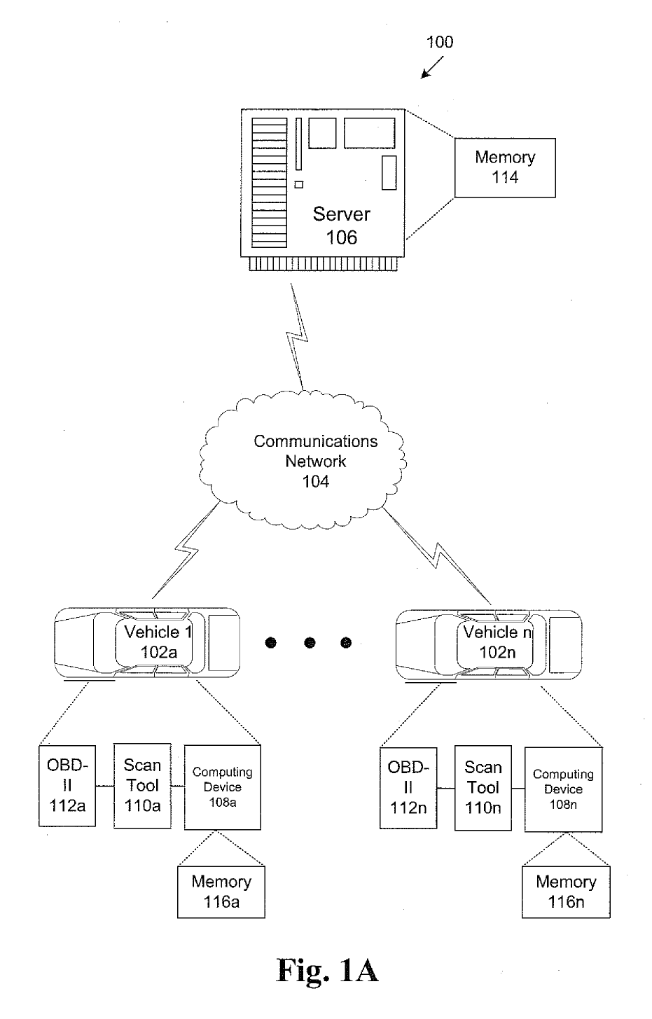

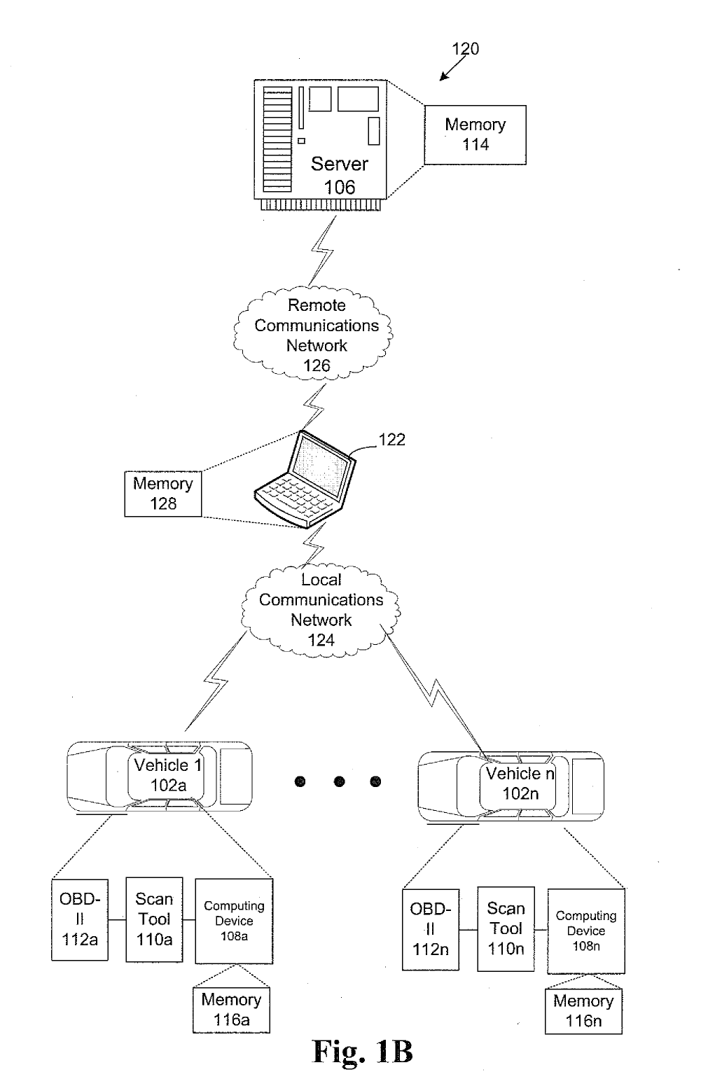

Referring now to the figures and in particular to FIG. 1A, there is shown schematically the system architecture of the present invention. In an embodiment, the system 100 is a vehicle diagnostic system that can be used to monitor and/or detect malfunctions or faults within the vehicle. The system 100 can be configured to monitor and/or detect faults in a single vehicle 102a or multiple vehicles 102a-102n, such as a fleet of vehicles. For example, without limitation, the system 100 may be used to detect fault(s) on one particular vehicle, or to detect fault(s) common to a fleet of the vehicles. As such, the system 100 can have one or more vehicles 102a-102n in communication through a communication network 104 with a server computer 106. The server 106 contains, at a minimum, a processor (not shown), a network interface (not shown), and a memory device 114. The communication network 104 can be any type of wired or wireless communication link or network, or combination thereof, that is capable of facilitating communications between the server computer 106 and the vehicle(s) 102a-102n.

Each vehicle 102 has a computing device 108a-108n which is in communication through a scan tool 110a-110n with an on-board diagnostic system 112a-112n. The computing device 108a-108n can be any type of computing device, such as without limitation, a personal display assistant (“PDA”), notebook, laptop, computer, server, cell phone, and the like. The computing device 108a-108n contains, at least, a processor (not shown), a network interface (not shown) and a memory device 116a-116n. The computing device 108a-108n communicates through the communication network 104 to the server computer 106.

In an alternate embodiment shown in FIG. 1B, the system 120 is configured with an intermediate computing device 122 that is in communication with the server computer 106 and each of the computing devices 108a-108n in the vehicles 102a-102n. This type of configuration may be beneficial in situations where the intermediate computing device 122 is located closer to the monitored vehicle(s) 102a-102n and the server 106 is located in a remote geographic location. There can be a local communication network 124 in communication with the vehicles 102a-102n and the intermediary computing device 122. Additionally, there may be a remote communications network 126 coupled to the intermediate computing device 122 and the server 106. The intermediate computing device 122 can be any type of computing device, such as without limitation, a cell phone, PDA, notebook or laptop computer, computer, server, and the like. The intermediate computing device 122 has, at a minimum, a processor (not shown), a network interface (not shown), and a memory device 128. The local communication link 124 and the remote communications network 126 can be any type of wired or wireless communication link or network, or combination thereof, that is capable of facilitating communications between the coupled devices.

Although the system architecture has been described above with respect to the above configurations, the present invention is not constrained to these configurations. One skilled in the art can readily adapt this system architecture to a wide variety of configurations to which the technology described herein would apply.

Referring to FIGS. 1A and 1B, each vehicle 102a-102n is equipped with an on-board diagnostic system 112a-112n, such as the on-board diagnostic system, generation 2, referred herein as OBD-II system 112a-112n. In each vehicle 102a-102n, there is an OBD-II type connector located in the passenger compartment (not shown) that plugs into the scan tool 110a-110n. The scan tool 110 is used to retrieve the diagnostic sensor data from the OBD-II system 112. Alternatively, the scan tool 110 can be a software application loaded in the computing device 108a-108n.

The OBD-II system 112a-112n interfaces with sensors, located within the vehicle, which monitor various engine functions, emissions, etc. The OBD-II system 112a-112n operates in accordance with several OBD-II standards and in particular, the OBD-II standard SAE J1979, that defines the protocol for requesting the diagnostic sensor data and its associated values. The data retrieved from the OBD-II system is addressed by parameter identification numbers or PIDs. A query is sent to the OBD-II system using a requested PID and a response is returned including, at least, the current value.

For illustration purposes, Table 1 is provided below to show a few exemplary PIDs, the expected response for each PID, and information on how to interpret the response.

TABLE 1

| | Data | | | | | |
|---|---|---|---|---|---|---|
| PID | bytes | | Min | Max | | |
| (hex) | returned | Description | Value | Value | Units | Formula |
| 04 | 1 | Calculated engine load value | 0 | 100 | % | A * 100/255 |
| 05 | 1 | Engine coolant temperature | −40 | 215 | ° C. | A − 40 |
| 06 | 1 | Short term fuel % trim - Bank 1 | −100 | 99.22 | % | (A − 128) * |
| | | | (Rich) | (Lean) | | 100/128 |
| 07 | 1 | Long term fuel % trim - Bank 1 | −100 | 99.22 | % | (A − 128) * |
| | | | (Rich) | (Lean) | | 100/128 |
| 08 | 1 | Short term fuel % trim - Bank 2 | −100 | 99.22 | % | (A − 128) * |
| | | | (Rich) | (Lean) | | 100/128 |
| 09 | 1 | Long term fuel % trim - Bank 2 | −100 | 99.22 | % | (A − 128) * |
| | | | (Rich) | (Lean) | | 100/128 |
| 0A | 1 | Fuel pressure | 0 | 765 | kPa | A * 3 |
| | | | | | (gauge) | |
| | | • • • | | | | |
| 0C | 2 | Engine RPM | 0 | 16,383.75 | rpm | ((A * 256) + B)/4 |

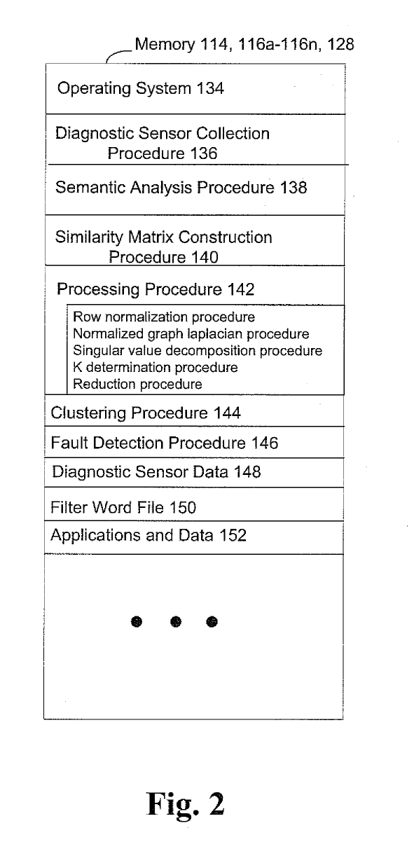

Referring to FIG. 2, there is shown an exemplary layout for memory devices 114, 116a-116n, and 128. Each memory device 114, 116a-116n, and 128 is a computer readable medium that can store executable procedures, applications, and data. It can be any type of memory device (e.g., random access memory, read-only memory, etc.), magnetic storage, volatile storage, non-volatile storage, optical storage, DVD, CD, and the like.

Each memory device 114, 116a-116n, and 128 can contain instructions and data as follows:
an operating system 134;
a diagnostic sensor collection procedure 136;
a semantic analysis procedure 138;
a similarity matrix construction procedure 140;
a processing procedure 142;
a clustering procedure 144;
a fault detection procedure 146;
diagnostic sensor data 148;
filter word file 150; and
various applications and data 152.

The functions of each of these procedures will be discussed in further detail below.

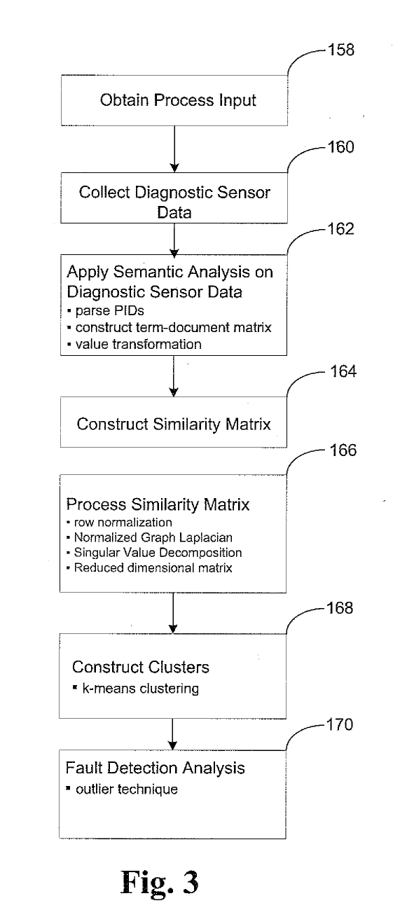

Referring to FIG. 3, there is shown an embodiment of the process employed by systems 100, 120 in further detail. In step 158, some process input is obtained from a user. In particular, a filter word file 150 and the value for the parameter, number_of_extra_clusters. Each of these inputs will be discussed further below.

In step 160, the diagnostic sensor collection procedure 136 in one or more vehicles 102a-102n is activated to collect the PID data. This procedure 136 can be activated to run continuously, be programmed to collect the data at certain select time intervals, or collect data in any other manner. The diagnostic sensor collection procedure 136 is used to interface with the scan tool 110a-110n which queries the ODB-II system 112a-112n for this data. Preferably, the procedure 136 stores the PID hex code, the description of the PID, its value, and the associated unit, for each PID, in memory 148.

Next, in step 162, the semantic analysis procedure 138 constructs a term-document matrix from the diagnostic sensor data 148. The term-document matrix, M, has the PID descriptions (e.g., “engine coolant temperature”, etc.) as its rows and the single words or terms used in the PID descriptions (e.g., “engine”, “temperature”, etc.) and their corresponding units (e.g., “%”, “⁰C”, “volts”) as its columns. The procedure 138 parses the PID descriptions to obtain these single terms for use as the columns. The procedure 138 computes each entry in the term-document matrix as the number of occurrences a particular term appears in a PID description. This matrix, M, can be quite large. For example, in the case where there are 100 PIDs and there are 1,000 single words in the PID descriptions, the matrix would have 100 rows and 1000 columns.

For illustration purposes, Table 2 below illustrates a portion of an exemplary term-document matrix.

TABLE 2

| | | | Temper- | | | | |
|---|---|---|---|---|---|---|---|
| | Engine | Coolant | ature | Fuel | Pressure | RPM | • • • |
| Engine | 1 | 1 | 1 | | | | |
| Coolant | | | | | | | |
| Temper- | | | | | | | |
| ature | | | | | | | |
| Fuel | | | | 1 | 1 | | |
| Pressure | | | | | | | |
| Engine | 1 | | | | | 1 | |
| RPM | | | | | | | |
| • • • | | | | | | | |

Next, procedure 138 applies some processing to the term-document matrix (step 162). The procedure determines which terms are irrelevant and deletes them from the term-document matrix. For example, the term “Present” in the PID description “Oxygen Sensor Present” may have no relevance to the process and as such, the corresponding column in the matrix would be deleted. The filter word file 150 contains a list of words that are considered irrelevant and is used in this step to eliminate the irrelevant terms. Next, the procedure 138 applies some transformation techniques on the values, such as handling missing values and scaling the values. This is performed, in part, to reduce computational overhead.

In step 164, the similarity matrix construction procedure 140 constructs a similarity matrix. The similarity matrix is a matrix of scores representing the degree of similarity between two PID descriptions. A higher score is indicative of a strong similarity while a lower score indicates little or no similarity. The similarity matrix is an N×N matrix, where N is the number of PID descriptions. The entries in the similarity matrix are positive values.

In one embodiment, the similarity matrix is computed from the term-document matrix as follows:

W=M×M^{T}, where M is the term-document matrix, and M^{T} is the transpose of M. W is herein denoted as the semantic similarity matrix.

For illustration purposes, Table 3 below illustrates a portion of an exemplary similarity matrix.

TABLE 3

| | Engine | | | |
|---|---|---|---|---|
| | Coolant | Fuel | Engine | |
| | Temperature | Pressure | RPM | • • • |
| Engine Coolant | 3 | 0 | 1 | |
| Temperature | | | | |
| Fuel Pressure | 0 | 2 | 0 | |
| Engine RPM | 1 | 0 | 2 | |
| • • • | | | | |

Alternatively, the similarity matrix can be constructed as combination of several similarity matrices with non-negative entries. Other similarity matrices can be used based on other PID information and relationships, including previously collected PID data. Mathematically, this construction is represented as follows:

W′=(a₁×S₁)+(a₂×S₂)+ . . . +(aₙ×Sₙ),

where a₁>0, a₂>0, . . . , aₙ>0, a₁+a₂+ . . . +aₙ=1, and S₁, S₂, . . . Sₙ are symmetric positive definite with non-negative entries.

For example, this similarity matrix, W′, can be constructed as follows:
W′=(0.5×W)+(0.5×W^{c}), where W is the semantic similarity matrix, W^{c} is a co-occurrence matrix (described below), a₁=0.5, a₂=0.5, S₁=W, and S₂=W^{c}.

The similarity matrix, W′, has the advantage of incorporating semantic and numerical domain-specific information related to the PIDs into the matrix and as such, enhances the reliability of the data in the matrix.

In another embodiment, W is a binary matrix (a matrix with only entries 0 or 1), where Wᵢⱼ, the entry in row i and column j, is 1 if PID i and PID j have a term in common, and 0 otherwise.

In another embodiment, the similarity matrix is a co-occurrence matrix, W^{c}, that represents the strength of the relationship between two PIDs by the frequency with which data messages for the two PIDs are received within the same time window (of a given length, which can be specified by the user). As noted above, the queries for the diagnostic data are requested within a particular time frame or window and the response to these queries is a data message.

In another embodiment, the similarity matrix is a binary co-occurrence matrix W^{bc}, where W^{bc}ᵢⱼ is 1 if PID i and PID j co-occur in the same time window, and 0 if they do not.

The similarity matrix is then used to form a similarity graph G=(V, E). The vertices in this graph vᵢ represent a particular PID, xᵢ. Two vertices are connected if there is a similarity between the two vertices, vᵢ and vⱼ, and the edge between them is weighted with a similarity score, sᵢⱼ. The graph is partitioned so that edges between different groups have a low similarity score and edges within a group have a high similarity score. The goal is to find the best way to partition the graph into similarly-situated groups. This is accomplished by transforming the similarity matrix into a normalized graph Laplacian to which singular value decomposition is applied. This will result in a diagonal matrix, D, having zero-valued singular values. The zero-valued singular values represent connected components and the number of such components is used as the lower bound for the value of k. The singular value decomposition will produce a matrix, U, from which a reduced matrix is formed and used as the compact representation of the semantic structure. This processing is discussed in more detail below with respect to the processing in step 166.

The processing procedure 142 applies additional processing, in step 166, on the similarity matrix, W′. First, row normalization is applied to the norm 1 in order to bring the data to a common scale. This is represented mathematically as follows and produces the normalized similarity matrix, P:
For each row i and column j, W′ᵢⱼ=W′ᵢⱼ/(Σ_{j=1 to T}, W′ᵢⱼ), where T=number of PIDs.

Next the normalized graph Laplacian is applied to the normalized similarity matrix, P as follows:
L=I−P, where I is the identity matrix of the same dimension as P.

The normalized graph Laplacian transforms the semantic space into probabilities within the range (0,1).

Next, the procedure 142 applies singular value decomposition to P thereby decomposing L into three matrices as follows:
L=UDU^{T}, where D is a diagonal matrix, and U^{T} is the transpose of U.

Singular value decomposition is applied to eliminate “noise” and to reduce the dimensionality of the semantic space. The use of the semantic structure is computationally intensive since it involves highly dimensional data. For this reason, a more compact representation is required that preserves the locality of the data. The application of the singular value decomposition of the normalized graph Laplacian provides such a compact representation.

D is a diagonal matrix whose diagonal elements are the singular values of L. The number of zero-value singular values is used as the lower bound k_min for k. The final value of k is determined as follows: k=kₘᵢₙ+number_of_extra_clusters, where number_of_extra_clusters is a user-defined parameter. The similarity matrix is then reduced to containing the last k columns of matrix U and is denoted as UK, having N rows and k columns.

In step 168, the value of k and the matrix UK is transferred to the clustering procedure 144. Preferably, procedure 144 is the k-means clustering technique. The procedure 144 groups the rows of UK into k distinct clusters, C₁, C₂, . . . , Cₖ.

In step 170, the fault detection procedure 146 uses the clusters, C₁, C₂, . . . , Cₖ, the sensed diagnostic measurement data associated with the PIDs, and an outlier detection technique to identify any outliers, or data points that are distant from the center points in a cluster. These outliers are used to identify potential malfunctions or faults.

For illustration purposes, Table 4 below illustrates some exemplary results from the fault detection procedure 146. There is shown several graphs from one cluster. The cluster represents the TransOil Temperature, Engine Coolant Temperature, and Oil Sensor Temperature PIDs. Each graph represents data collected during the month of March. The outliers are the diamond-shaped points and the black lines represent the non-outlier data points.

The process described herein analyzed all the measurement data for these three PIDs together in order to determine outliers for each PID. In this manner, the technique takes into consideration other factors which can affect a measurement thereby using more domain knowledge and yielding more reliable results. The grouping of these PIDs was done based on the similarity of the PID descriptions. In addition, this technique is performed automatically and does not require manual intervention by a user.

The foregoing description, for purposes of explanation, has been described with reference to specific embodiments. However, the illustrative teachings above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

Although the discussion of the embodiments herein have been described with respect to automotive diagnostics, these same techniques can be applied to other real-time on-board monitoring applications, such as without limitation, aviation systems, space vehicles, security surveillance, and the like. Furthermore, one skilled in the art can apply these same techniques to other applications utilizing clustering or data mining techniques, such as without limitation, monitoring patient health, monitoring weather patterns, radar data on planes, character recognition, speech recognition, and the like.

It should be noted that the present invention is not constrained to the k-means clustering technique and other clustering techniques, such as agglomerative clustering or hierarchical clustering techniques can be employed as well. Likewise, other techniques can be used instead of the outlier detection technique, such as, search, visualization, or quick classification techniques.

The steps described above with respect to FIG. 3 can be performed in a number of configurations. In one embodiment, all the steps are executed in the vehicle's computing device 108. Alternatively, certain procedures can be executed in the vehicle's computing device 108a-108n while others can be executed in the intermediate computing device 122 or the server 106, or a combination thereof. For example, in the case where there is a voluminous amount of diagnostic sensor data 148 and the vehicle's computing device 108a-108n is not equipped to process such data, the diagnostic sensor data collection procedure 136 can execute on the vehicle's computing device 108a-108n and forward the diagnostic sensor data to the intermediate computing device 122 or server 106, as the case may be, to further execute the steps shown in FIG. 3. The manner in which the process is executed is not a limiting factor to the technology described herein and any configuration can be used.

The construction of the similarity matrix has been described above with respect to using frequencies from the term-document matrix. It should be noted that these frequencies can be weighted. For example, the term “temperature” can be given a high weight that is applied to the frequency of all PIDs using this term thereby given these PIDs a higher similarity score. The weights would recognize terms that are more significant. These weights could be inputted through a file and incorporated into the process automatically during the similarity matrix construction or even in the term document matrix construction steps.

What is claimed is:

1. A method for automatically detecting faults in a machine, comprising the steps of:
collecting a plurality of diagnostic data from the machine, the diagnostic data including a plurality of descriptions and a plurality of numerical values, each numerical value associated with a select one of the descriptions and representing a measurement from the machine;
analyzing the descriptions of the diagnostic data to formulate a semantic structure representing the machine;
grouping the semantic space into k clusters, each cluster having semantic-similar descriptions; and
for each cluster, detecting anomalies by using the measurement data associated with all the descriptions in the cluster, the anomalies for use in indicating a machine fault.

2. The method of claim 1 further comprising the step of:
collecting the diagnostic data from the machine during operation of the machine.

3. The method of claim 1, the analyzing step further comprising the step of:
formulating the semantic structure from a frequency analysis of semantically-significant words used in the descriptions.

4. The method of claim 3, the analyzing step further comprising the step of:
adjusting the semantic structure to include correlations of the numerical values associated with the descriptions.

5. The method of claim 1, wherein the descriptions are word phrases used to describe parameter identification numbers associated with an on-board diagnostic system.

6. A computer readable storage medium for use in automatically detecting machine faults, said apparatus comprising:
a similarity graph having a plurality of edges and vertices, each vertex vᵢ representing a description of a diagnostic parameter associated with the machine, and each edge weighted by sᵢⱼ, where sᵢⱼ represents a similarity score between vertex vᵢ and vertex vⱼ;
a first procedure that finds k groups of connected components in the graph, where each edge in a group has a high similarity score;
a second procedure that generates a subset of the graph, UK, representing the groups of connected components;
a clustering procedure that groups UK into k clusters, where each cluster k represents similarly-situated descriptions that are used to identify anomalies indicative of a machine fault within the cluster.

7. The apparatus of claim 6, further comprising:
a term-document matrix of size N×M and having entries, d_{ab}, where M denotes a number of terms taken from the N descriptions, each entry d_{ab}, representing a frequency score between description a and term b.

8. The apparatus of claim 7, further comprising:
a similarity matrix of size N×N, having entries wᵢⱼ, where N denotes a number of the descriptions, and wᵢⱼ denotes a score indicating a semantic similarity between description i and description j;
a third procedure that constructs the similarity matrix from the term-document matrix; and
a fourth procedure that constructs the similarity graph from the similarity matrix.

9. The apparatus of claim 8, wherein the third procedure constructs the similarity matrix as a combination of a plurality of additional similarity matrices, each additional similarity matrix representing data associated with the machine.

10. The apparatus of claim 6, wherein the similarity graph is a normalized graph Laplacian, L.

11. The apparatus of claim 10, wherein the first procedure further comprises:
a singular value decomposition procedure that is applied to the similarity graph, L, thereby generating a diagonal matrix D, and matrix U.

12. The apparatus of claim 11, wherein the first procedure
determines the value k equal to a number of zero-valued singular values in D.

13. The apparatus of claim 11, wherein the second procedure
forms UK, having N rows of U and last k columns of U.

14. The apparatus of claim 6, further comprising:
a diagnostic sensor collection procedure that collects diagnostic data from the machine, the diagnostic data containing the descriptions.

15. The apparatus of claim 6, further comprising:
a fault detection procedure that analyzes measurement data from the machine that corresponds to each description in a cluster for anomalies indicative of the machine faults.

16. A system for automatically detecting machine faults, said apparatus comprising:
a first processor that senses and collects diagnostic data from the machine, the diagnostic data having a plurality of descriptions and measurement values;
a second processor, in communication with the first processor, that
receives the diagnostic data from the first processor,
generates a semantic structure of the machine from the descriptions,
groups the semantic structure into k clusters, each cluster having semantically-situated descriptions,
for each cluster, analyzes the measurement values associated with the descriptions included in each cluster for outliers that can be indicative of a machine fault.

17. The system of claim 16,
wherein the second processor uses a normalized graph Laplacian to generate a semantic structure of the machine.

18. The system of claim 17,
wherein the second processor applies a singular value decomposition to the normalized graph Laplacian to determine k.

19. The system of claim 16,
wherein the second processor applies a singular value decomposition to the normalized graph Laplacian to generate a subset of the semantic structure, UK, that is used to generate the k clusters.

20. The system of claim 19,
wherein the second processor uses a k-means clustering to generate k clusters from UK.
